(19) United States
(12) Patent Application Publication
(10) Pub. No.: US 2013/0311385 A1
(43) Pub. Date: Nov. 21, 2013

(54) Third Party Security Monitoring & Audit

(71) Applicant: Park S. Foreman, Summit, NJ (US)

(72) Inventor: Park S. Foreman, Summit, NJ (US)

(21) Appl. No.: 13/475,874

(22) Filed: May 18, 2012

(51) Int. Cl. G06Q 99/00

(52) U.S. Cl. 705/317

(57) ABSTRACT

The technology disclosed in this specification includes a method and a system for monitoring external party (partner, supplier, subsidiary or similar organization) security events and monitoring compliance of third party security logs and configuration files within agreed upon rules. The embodiment a) integrates with system logging utilities to collect event information, b) identifies events that are relevant to an established set of rules, c) reports the events to the primary party, d) receives on the third party system audit requests from the primary party and executes the audit actions on the third party systems, e) performs the required verifications on the third party specified in the audit requests, f) sends the audit results back to the primary party.

### BACKGROUND

Threats are a growing concern in information security since they can originate from many locations and via many methods over a long period of time. One source of threats is the external party with which an organization establishes digital connections. Attackers may slowly infiltrate an external party with an ultimate goal of attacking the primary target. Standard, uniform information sharing of security events is not well established among related organizations. Consequently, getting advance, actionable security information is difficult and therefore lessens the adaptability of security processes and technologies. The auditing and compliance monitoring functions in this specification address these problems.

### TECHNICAL PROBLEM

Typically, there are no standard technological methods and procedures for sharing selected security events in a trusted fashion between an organization and a third party. Furthermore, there are no automated methods for auditing compliance with the terms of security event sharing.

### SUMMARY OF THE INVENTION

A business or government agency can establish a security relationship with external organizations whereby security event and posture information can be automatically shared. This shared information can then be analyzed for relevant threats. The invention enables the exchange of selected security events and compliance monitoring information through automated means. The primary party can audit the agreed upon security event monitoring configuration rules on the third party's systems and further receive forwarded security events matching the configured rules.

### BRIEF DESCRIPTION OF SEVERAL DRAWINGS

FIG. 1 shows the data flow and processing from the third party to the primary organization.

FIG. 2 shows the process of handling 3^{rd} party events using the Third Party Security Event Exchange tool. Items in the boxes represent the technology and process developments for this project. In most cases, the technology is relatively simple code that is implemented in the log management hardware and software. The processes support the use of this technology through the addition of a few steps in the configuration and maintenance processes for the logging systems.

FIG. 3 shows the process that is followed by the auditing engine when an audit is initiated at 103.

FIG. 4 shows a sample computer system and the components that may be used in the invention.

### DETAILED DESCRIPTION OF THE INVENTION

Before implementing this invention, two parties agree upon the rules which specify the events to be sent from the third party, B to the first party, A. Those rules are stored in one or more configuration files in the Management Module at 103 and used by the “TSEE Engine” at 109. To verify that the security event-logging configuration on the third party system has not been tampered with, “Auditing Engine” at 108 stores the approved configuration items. A cryptographic hash algorithm such as MD5 of SHA1 is used to monitor each configuration file on 103 for unauthorized changes. These cryptographic hashes are retained on the first party “Administrator Module” at 102.

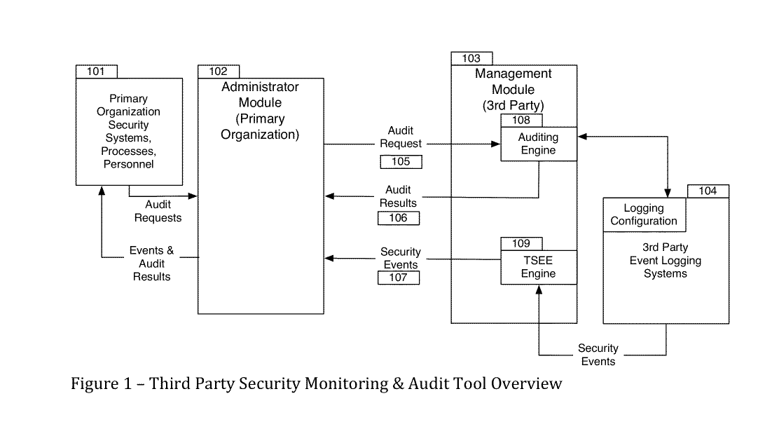

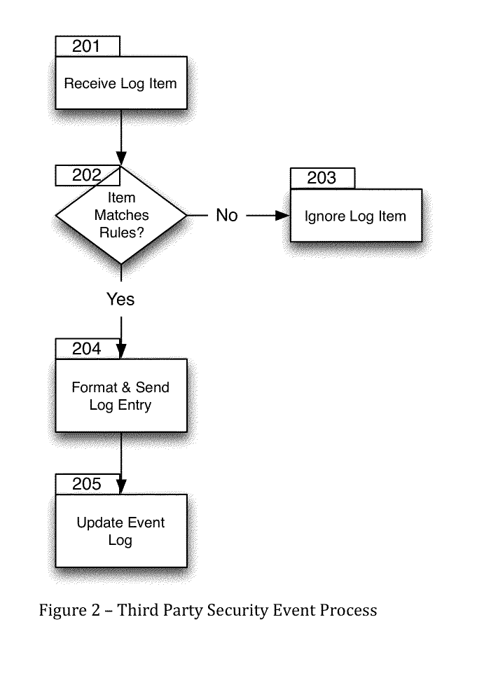

FIG. 2 shows the process followed in receiving and forwarding security events in third party management module referenced in FIG. 1 at 103. The invention employs a simple protocol for communicating event information consolidated in FIG. 1 at one or both of 103 and 104.

When a security event is generated at the third party event logging system at 104, it is checked by the TSEE engine at 109 to see if it matches one of the previously agreed upon rules. If the rule is matched, the security event is forwarded at 107 to the Administrator Module at the Primary Organization. FIG. 2 shows the process of handling event log items provided to the TSEE engine.

At 201, an event log item is received through any required method necessary to the third party logging system. At 202 the event is compared against the rules specified in the configuration of the TSEE engine. If no match is found in the rules, the event is discarded at 203. If the event matches a rule, it is formatted and sent using the TSEE protocol at 204. Once the event is sent, a TSEE log entry is made at 205 to track the collection of the event for later auditing.

Auditing is performed using the auditing engine in FIG. 1 at 108, an audit request at 105 and an audit request originating from 102.

When the first party wishes to verify the integrity of the third party management module at 103, a request is sent from the administrator module at 102 to the auditing engine at 103 using a standard protocol at 105. To perform an audit, a message is originated from the primary organization at 102 to request an audit process be performed at the third party Management Module at 103 using the Auditing Engine at 108.

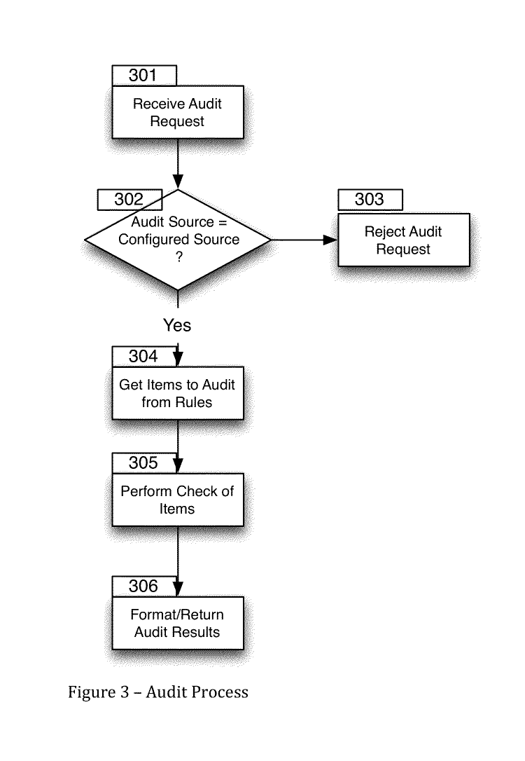

FIG. 3 shows the audit process when the audit request is received. Upon receipt by the third party at 301, the auditor identification is checked at 302 to assure that the source of the requesting system is consistent with the connection to the requestor using a public/private key and hash algorithm or similar standard method. If the requestor is not verifiable, the request is rejected.

If the audit request is correctly verified then the configuration is checked at 304 to get a list of the items to be audited. This list may include specific configuration lines in a file or database or other means to check for the presence of a required audit item.

The checks are then performed at 305 using various methods as required by the system to be audited. This may include simple checks of text files of execution of code or command scripts on the audited system that may return results to the auditing function. Either simultaneously or subsequent to 306, the audit report is formatted and transmitted back to the requesting party at 306.

The audit report may include a summary of the range of days specified by the auditor and details a list of the last X messages from the audit log where X is the number of messages desired within the limits of the agreed upon configuration. The entire report may be subjected to a cryptographic hash to provide for integrity monitoring and possibly to avoid transmitting the entire report but the hash value instead. Each time the rules are changed at 108 or 109, the agreement details must be amended and a new cryptographic hash generated and stored at 102. The audit report can be generated on demand and sent over the established connection as needed using standard protocols such as SSL. The audit results are sent to the requestor for verification.

There may be multiple configurations of rules at 108 and 109 to allow a third party to send event log messages and audit results to multiple first party organizations using separate rule sets.

A set of rules is used to select and transmit the event log information. The security administrator at 102 can use an administrative interface to permit modification of individual rules.

The administrators at 102 can optionally implement integrated methods to authenticate the audit requests, audit results and the security events forwarded.

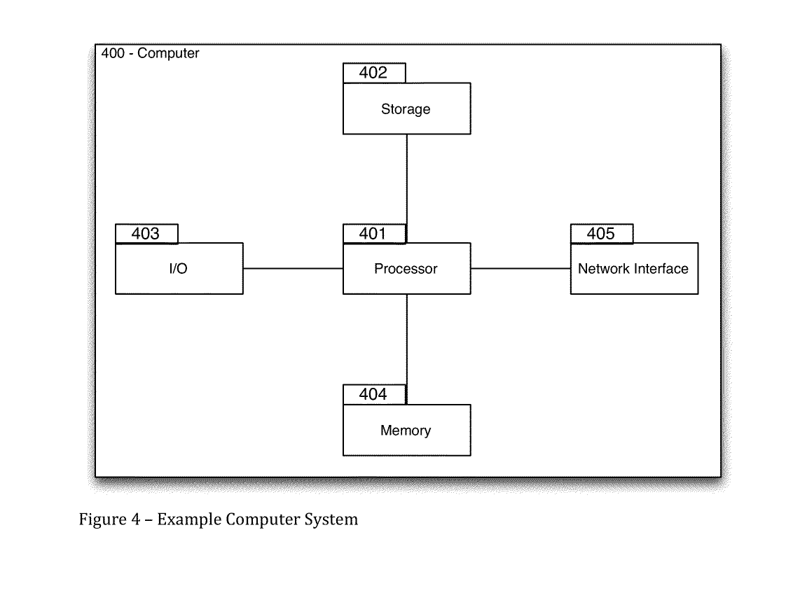

The above-described methods may be implemented on computers using well-known computer processors, memory units, storage devices, computer software and other components. A high-level block diagram of such a computer is illustrated in FIG. 4. The computer 400 contains a processor 401 which controls the overall operation of the computer along with computer program instructions which define such operation. The computer program instruction may be stored in a storage device 404, or other computer readable medium and loaded into memory 405 when execution of the computer program instructions is desired. The method steps of FIGS. 1, 2, and 3 can be defined by the computer program instructions store in the memory 404 and/or storage 402 and controlled by the processor 401 executing the computer program instructions. For example, the computer program instructions can be implemented as computer executable code programmed by on skilled in the art to perform an algorithm defined by the method steps of FIGS. 1, 2 and 3. Accordingly, the executing the computer program instructions, the processor 401 executes and algorithm defined by the methods of FIGS. 1, 2 and 3. The computer also includes one or more network interfaces 405 for communicating with other devices via a network. The computer 400 also includes other input/output devices 403 that enable user interaction with the computer 400. One skilled in the art will recognize that an implementation of an actual computer could contain other components as well, and that FIG. 4 is a high level representation of some of the components of such a computer for illustrative purposes.

The foregoing Detailed Description is to be understood as being in every respect illustrative and exemplary, but not restrictive and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention.
1. A method for collecting and transmitting security event data from a third party computer system or network.
2. The method of claim 1 further comprising: rules determining which security events apply to parties generating the security events and parties receiving the events.
3. The method of claim 1 further comprising: enabling authorized parties outside of the third party to conduct audits to confirm the configuration status of rules in claim 2 and security events transmitted in claim 1.
4. The method of claim 1 wherein the security events are transmitted from a third party to the primary party.
5. The method of claim 2 wherein the rules are audited upon request of the primary party.

6. A computer readable medium encoded with computer executable instructions for receiving and sending security events, the computer executable instruction defining steps compromising:
a. Receiving security events from a third party logging system
b. Comparing the security events against a set of rules
c. Formatting and sending security events based on claim 6b.
7. The computer readable medium of claim 6, further comprising computer executable instructions defining the step of:
   a. Send and receiving audit requests
   b. Executing the audit requested
   c. Formatting and returning the audit results to the requestor
      only illustrative of the principles of the present invention and that various modifications may be implemented by those skilled in the art without departing from the scope and spirit of the invention.
1. A method for collecting and transmitting security event data from a third party computer system or network.
2. The method of claim 1 further comprising: rules determining which security events apply to parties generating the security events and parties receiving the events.
3. The method of claim 1 further comprising: enabling authorized parties outside of the third party to conduct audits to confirm the configuration status of rules in claim 2 and security events transmitted in claim 1.
4. The method of claim 1 wherein the security events are transmitted from a third party to the primary party.
5. The method of claim 2 wherein the rules are audited upon request of the primary party.
6. A computer readable medium encoded with computer executable instructions for receiving and sending security events, the computer executable instruction defining steps compromising:
   a. Receiving security events from a third party logging system
   b. Comparing the security events against a set of rules
   c. Formatting and sending security events based on claim 6b.
7. The computer readable medium of claim 6, further comprising computer executable instructions defining the step of:
   a. Send and receiving audit requests
   b. Executing the audit requested
   c. Formatting and returning the audit results to the requestor

The embodiments of the invention in which an exclusive property or privilege is claimed are defined as follows:

1. A security event collection and audit system comprising:
a. A third party management module designed to receive logging events from broadly used event logging systems, perform audits of the logging configuration and send events and audit results to the primary organization's administrator module and
b. An administrator module that receives events and audit results and sends requests for audits to the third party management module.

2. The third party management module defined in claim 1 collects security events from an available event logging system and compares the events with a set of rules.

3. The events that comply with rules in claim 2 are forwarded electronically to the primary organization administrator module specified in claim 1b.

4. The third party management module in claim 1a can receive audit requests from an authorized administrator module in claim 1b.

5. The administrator module can create and send audit requests to the third party management module in claim 1a.

6. The third party management module can perform the audit actions specified by the administrator module in claim 5.

7. The third party management module sends audit results to the administrator module in claim 1b.
